(19) United States
(12) Patent Application Publication
(10) Pub. No.: US 2006/0288136 A1
(43) Pub. Date: Dec. 21, 2006

(54) Device used to enable and disable internet connection

(76) Inventor: Gregory Jon Weise, Georgetown, KY (US)

Correspondence Address: GREGORY WOISE, 217 LEXINGTON AVE, GEORGETOWN, KY, 40324, US

(21) Appl. No.: 11/434,598

(22) Filed: May 15, 2006

Related U.S. Application Data
(60) Provisional application No. 60/682,499, filed on May 19, 2005.

(51) Int. Cl. G06F 3/00

(52) U.S. Cl. 710/58

(57) ABSTRACT

All three drawing number's are indicative only of the submitted drawing. Internet connection device with a seven day digital programmable timer, indicated in drawing numbering @ 1. This shuts off and on the Ethernet signal coming from a cat 45 or similar Ethernet cable identified in the drawing numbering @ 2. Signal is cut off through the device via a double pole double throw relay, identified in the drawing numbering @ 3. No other internal components are needed or exist in this device for operation.

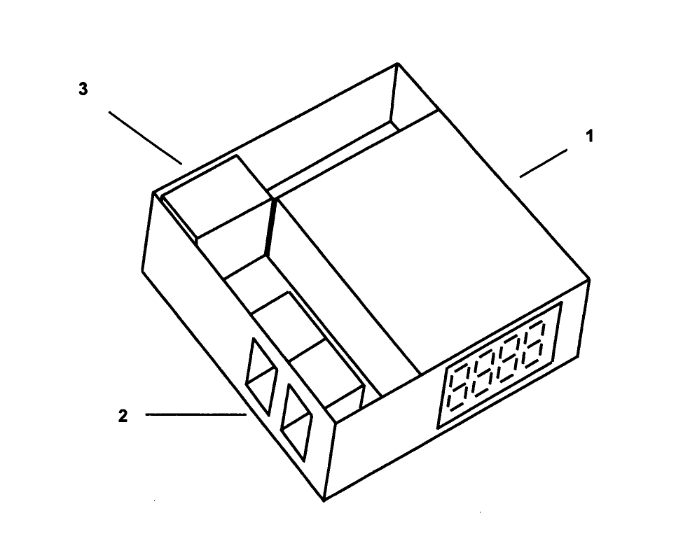

### FIELD OF THE INVENTION

The invention relates generally to computer interface devices, and more particularly a device used as intermedium devices between a network gateway device and high speed Internet modems or broadband connections.

### BACKGROUND OF THE INVENTION

This device allows the owner to disable the Internet connection for one computer or multiple networked computers through a digital programmable timer. This allows the owner to program the time allocation of the day for internet usage, or up to seven days of Internet usage at the set prescribed times of the owner.

This allows parents to manage the time spent on the Internet with supervision and to guard access against inappropriate material found on the World Wide Web. By regulating the time the parent or owner permits usage of the internet. It allows the employers to control access to the internet of their employees for unauthorized usage of the net.

There are many software programs out there that our no more than filtering devices. They allow only parents to block out inappropriate material on the web. Many of these different types of software can be found at sites such as www.internetfilterreview.com. The problem with these software programs is that there are millions of web pages being added weekly and it is impossible for any Program to censor and block one hundred percent of these sites.

Consumer Reports tested many of these different types of software products. Most of the products they tested failed to block 1 in 5 objectionable sites. (Consumer Reports, “Digital chaperones for kids,” March 2001). Also this software filtering/blocking software can be disabled by their children. There are sites that give step by step instructions on how to disable and remove the software. This device being hardware only, cannot simply be disabled by a few simple clicks off the mouse.

1. Field of the Invention

This invention relates to any type of Internet connection that uses a hardware connection connected for Internet usage and can be used also through a networked gateway device. This device is compatible with all computer systems operating today.

2. Description of Related Art

With thousands of Internet users being added daily worldwide, the volume of connections is being increased in millions of homes across the United States, with very little option of regulating the usage of the internet of children and employees at their work. This device will allow for specific day and time regulation of Internet usage. This device has multi programmable setting capacity up to one week and/or seven day programming via digital time settings.

This device disables the Internet connection in the home and/or business by programmable settings through the hard wire connection of the Internet. Therefore, cutting off the Internet connection through a connecting device attached to the Ethernet cable.

### SUMMARY OF THE INVENTION

This present device relates to any device 120 voltage AC or battery powered, that intermittently disables the connection of the Internet through the opening of the appropriate paths of the hard wired connection, via programmable time and day settings of the timer.

### DETAILED DESCRIPTION OF THE PREFERRED EMBODIMENT.

Internet device consists of three main parts for operation. A seven day digital programmable timer, an in and out cat 45 or similar connector and a double pole double throw relay. Referring to the drawing numbering system of only three components designated as number 1, number 2 and number 3. The device operates by the owner/operator setting a time and day for on and off settings of the device located in the drawing numbering system as 1 and identified as the seven day digital programmable timer.

The internet or Ethernet is connected to the device by way of a non gender specific in and out cat 45, or comparable connector. The double throw double pole relay identified in the drawing as number 3, opens or closes the connection to the internet or Ethernet communication per the owners specified on and off setting at the seven day digital programmable timer, identified in the drawing at number @ 1.

The device operation is simple in nature. The seven day programmable timer allows the owner to set a on and off setting for usage of the internet. According to these settings the double pole double throw relay, opens or closes the internet connection to the in and out of the cat 45 or similar connector.

1. What is claimed is a device used to activate and deactivate an internet connection traffic pathway by a digital programmable timer. The digital programmable timer then can be set to a certain times for on and off to of connectivity to the internet.

2. System used to prevent individuals from accessing the internet during unauthorized times as per parent or owner discretion.

3. A tamper resistant cover apparatus used to prevent unauthorized access or override of the timer or the ability to bypass the unit.
